(19) United States
(12) Patent Application Publication
(10) Pub. No.: US 2015/0065153 A1
(43) Pub. Date: Mar. 5, 2015

(54) Arrangement for Enhanced Multi-Transmit Antenna Sounding

(71) Applicant: Nokia Corporation, Espoo (FI)

(72) Inventors: Mauri Nissila, Oulu (FI); Pekka Janis, Espoo (FI)

(21) Appl. No.: 14/389,736

(22) PCT Filed: Apr. 5, 2013
(86) PCT No.: PCT/FI2013/050365

§ 371 Date: Sep. 30, 2014

Related U.S. Application Data
(60) Provisional application No. 61/623,792, filed on Apr. 13, 2012.

(51) Int. Cl. H04B 7/04; H04L 5/00; H04L 25/02

(52) U.S. Cl. CPC H04B 7/0478; H04L 25/0226; H04L 5/0091
USPC 455/450

(57) ABSTRACT

One embodiment is directed to a method for enhanced multiple transmit antenna sounding. The method includes constructing, for example by a UE, an extended precoding matrix with mutually orthogonal column vectors, generating a reference signal (e.g., DMRS or SRS) sequence, precoding the reference signal sequence with each column vector of the extended precoding matrix to form a set of precoded sequences, mapping the set of precoded sequences to mutually orthogonal code, frequency, and/or time resources reserved for reference signals of the UE, and transmitting the references signals to, for example, an eNodeB.

### CROSS-REFERENCE TO RELATED APPLICATIONS

This application claims the benefit of U.S. provisional application Ser. No. 61/623,792 filed on Apr. 13, 2012. The contents of this earlier filed application are hereby incorporated by reference in its entirety.

### BACKGROUND

1. Field

Embodiments of the invention relate to wireless communications networks, such as the Universal Mobile Telecommunications System (UMTS) Terrestrial Radio Access Network (UTRAN) and Long Term Evolution (LTE) Evolved UTRAN (E-UTRAN).

2. Description of the Related Art

Universal Mobile Telecommunications System (UMTS) Terrestrial Radio Access Network (UTRAN) refers to a communications network including base stations, or Node Bs (or enhanced Node Bs in LTE-A discussed below), and radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS).

Long Term Evolution (LTE) or E-UTRAN refers to improvements of the UMTS through improved efficiency and services, lower costs, and use of new spectrum opportunities. In particular, LTE is a 3GPP standard that provides for uplink peak rates of at least 50 megabits per second (Mbps) and downlink peak rates of at least 100 Mbps. LTE supports scalable carrier bandwidths from 20 MHz down to 1.4 MHz and supports both Frequency Division Duplexing (FDD) and Time Division Duplexing (TDD).

As mentioned above, LTE is also expected to improve spectral efficiency in 3G networks, allowing carriers to provide more data and voice services over a given bandwidth. Therefore, LTE is designed to fulfill future needs for high-speed data and media transport in addition to high-capacity voice support. Advantages of LTE include high throughput, low latency, FDD and TDD support in the same platform, an improved end-user experience, and a simple architecture resulting in low operating costs.

Further releases of 3GPP LTE (e.g., LTE Release 11, and/or Release 12) are targeted towards future international mobile telecommunications advanced (IMT-A) systems, referred to herein for convenience simply as LTE-Advanced (LTE-A).

LTE-A is directed toward extending and optimizing the 3GPP LTE radio access technologies. A goal of LTE-A is to provide significantly enhanced services by means of higher data rates and lower latency with reduced cost. LTE-A will be a more optimized radio system fulfilling the international telecommunication union-radio (ITU-R) requirements for IMT-Advanced while keeping the backward compatibility

### SUMMARY

One embodiment is directed to a method. The method includes constructing, for example by a UE, an extended precoding matrix with mutually orthogonal column vectors, generating a reference signal (e.g., DMRS or SRS) sequence, precoding the reference signal sequence with each column vector of the extended precoding matrix to form a set of precoded sequences, mapping the set of precoded sequences to mutually orthogonal code, frequency, and/or time resources reserved for reference signals of the UE, and transmitting the references signals to, for example, an eNodeB.

Another embodiment is directed to an apparatus including at least one processor and at least one memory including computer program code. The at least one memory and the computer program code are configured, with the at least one processor, to cause the apparatus at least to construct an extended precoding matrix with mutually orthogonal column vectors, generate a reference signal (e.g., DMRS or SRS) sequence, precode the reference signal sequence with each column vector of the extended precoding matrix to form a set of precoded sequences, map the set of precoded sequences to mutually orthogonal code, frequency, and/or time resources reserved for reference signals of the apparatus, and transmit the references signals to, for example, an eNodeB.

Another embodiment is directed to an apparatus including means for constructing an extended precoding matrix with mutually orthogonal column vectors, means for generating a reference signal (e.g., DMRS or SRS) sequence, means for precoding the reference signal sequence with each column vector of the extended precoding matrix to form a set of precoded sequences, means for mapping the set of precoded sequences to mutually orthogonal code, frequency, and/or time resources reserved for reference signals of the UE, and means for transmitting the references signals to, for example, an eNodeB.

Another embodiment is directed to a computer program embodied on a computer readable medium. The computer program is configured to control a processor to perform a process. The process may include constructing an extended precoding matrix with mutually orthogonal column vectors, generating a reference signal (e.g., DMRS or SRS) sequence, precoding the reference signal sequence with each column vector of the extended precoding matrix to form a set of precoded sequences, mapping the set of precoded sequences to mutually orthogonal code, frequency, and/or time resources reserved for reference signals of a UE, and transmitting the references signals to, for example, an eNodeB.

Another embodiment is directed to a method for enhanced multiple transmit antenna sounding. The method includes selecting a PMI, signaling the PMI to a UE, receiving reference signals precoded with an extended precoding matrix, forming the extended precoding matrix based on the PMI, estimating a PUSCH channel and an unprecoded channel from the reference signals, and selecting a new PMI based on the unprecoded channel estimate.

Another embodiment is directed to an apparatus including at least one processor and at least one memory including computer program code. The at least one memory and the computer program code are configured, with the at least one processor, to cause the apparatus at least to select a PMI, signal the PMI to a UE, receive reference signals precoded with an extended precoding matrix, form the extended precoding matrix based on the PMI, estimate a PUSCH channel and an unprecoded channel from the reference signals, and select a new PMI based on the unprecoded channel estimate.

Another embodiment is directed to an apparatus including means for selecting a PMI, means for signaling the PMI to a UE, receiving reference signals precoded with an extended precoding matrix, means for forming the extended precoding matrix based on the PMI, means for estimating a PUSCH channel and an unprecoded channel from the reference signals, and means for selecting a new PMI based on the unprecoded channel estimate.

Another embodiment is directed to a computer program embodied on a computer readable medium. The computer program is configured to control a processor to perform a process. The process may include selecting a PMI, signaling the PMI to a UE, receiving reference signals precoded with an extended precoding matrix, forming the extended precoding matrix based on the PMI, estimating a PUSCH channel and an unprecoded channel from the reference signals, and selecting a new PMI based on the unprecoded channel estimate.

### BRIEF DESCRIPTION OF THE DRAWINGS

For proper understanding of the invention, reference should be made to the accompanying drawings, wherein:

FIG. 1 illustrates a flow diagram of a method according to one embodiment;

FIG. 2 illustrates a flow diagram of a method according to another embodiment;

FIG. 3 illustrates a block diagram of an example of in-band DMRS-based sounding, according to one embodiment; and

FIG. 4 illustrates an apparatus according to an embodiment.

### DETAILED DESCRIPTION

It will be readily understood that the components of the invention, as generally described and illustrated in the figures herein, may be arranged and designed in a wide variety of different configurations. Thus, the following detailed description of the embodiments of a system, a method, an apparatus, and a computer program product for enhanced multiple transmit antenna sounding as represented in the attached figures, is not intended to limit the scope of the invention, but is merely representative of selected embodiments of the invention.

If desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

Embodiments of the invention relate to the LTE-advanced system which is part of 3GPP LTE Rel. 11 and/or Rel. 12, as mentioned above. For example, embodiments relate to the uplink (UL) demodulation reference signal (DMRS) and UL sounding reference signal (SRS) arrangements. The DMRS is used for demodulation purposes and, when multiple transmit (tx) antennas are employed, it is precoded with the same precoding matrix as is applied for the corresponding physical uplink shared channel (PUSCH) transmission. The SRS is used for multiple purposes, such as for link adaptation and frequency domain scheduling in UL, for precoding matrix selection in UL, and, in TDD systems, also for downlink (DL) link adaption and precoding matrix selection. The 3GPP has been seeking enhancements for both DMRS and SRS, particularly in the context of cooperative multiple point (CoMP) transmission.

When the multiple-input multiple-output (MIMO) transmission modes for UL were under discussion, it was apparent that the capacity of SRS would be insufficient if many UEs in the cell employ MIMO at the same time. This is because each transmission antenna has to be sounded separately. As a response to the need for increased capacity, an a-periodic SRS (A-SRS) was introduced in the LTE Rel. 10 specification. The specified A-SRS configurations increase multiplexing efficiency of SRS significantly, thus having a positive effect on SRS capacity as well. However, recent discussions about various CoMP deployment scenarios, including different types of heterogeneous network (HetNet) scenarios, have again raised concerns about the sufficiency of SRS capacity.

From a UE's perspective, the optimal sounding arrangement is the one where the whole system bandwidth is sounded for all transmit antennas of the UE. Certainly, multi-tx-antenna sounding is an area where further enhancements would be needed, both from sounding capacity and flexibility points of view. One method to increase sounding capacity is to exploit DMRS resources for sounding purposes. Basically, there have been two different approaches under discussion in LTE standardization for DMRS-based sounding: 1) in-band DMRS-based sounding, where the DMRS of a UE is used for both demodulation purposes and sounding of the scheduled PUSCH frequency band of the UE, and 2) out-band DMRS-based sounding, where selected frequency bands outside of the PUSCH frequency allocation are sounded by exploiting available (unused) DMRS resources. Naturally, either one of the approaches or both could be used to increase uplink sounding capacity of the LTE network. On the other hand, SRS based multi-tx-antenna sounding could also be enhanced in terms of increased sounding flexibility and interference mitigation.

As will be discussed in detail below, embodiments of the invention provide viable solutions for in-band DMRS-based sounding in cases where a UE employs multiple transmit antennas. The main problem with the in-band DMRS-based sounding is that the precoded DMRS sequence as such cannot be used for sounding, except in the case of full-rank MIMO transmission where the precoding matrix is an identity matrix. In addition, solutions are provided that could improve an interference robustness of out-band DMRS-based sounding and SRS based sounding concepts in multi-tx-antenna settings.

Currently, in the presence of multiple tx antennas when PUSCH is precoded, then the DMRS is also precoded with the same precoding matrix. Thus, the same beamforming gain obtained for PUSCH transmission via precoding is also obtained for the DMRS. However, for multi-tx-antenna sounding purposes, the channel responses from all transmit antennas to a receive antenna have to be measured separately. In principle, the DMRS could be transmitted without precoding using separate DMRS sequences for different antennas since the eNB knows the precoding matrix that the UE applies for PUSCH transmission and, therefore, the eNB can perform demodulation of the PUSCH from the unprecoded DMRS with the aid of a-priori knowledge of the precoding matrix. This solution would, of course, allow in-band sounding from the DMRS but the solution has two major drawbacks: 1) the beamforming gain for the DMRS is lost, and 2) each transmit antenna requires its own orthogonal DMRS sequence (DMRS sequences of different transmit antennas can be made orthogonal, for example, via different cyclic shifts) even if reduced rank PUSCH transmission is assumed. The first drawback may be a more serious issue since the beamforming gain can be quite substantial for cell edge UEs. In existing out-band DMRS and SRS based sounding solutions, multiple tx antennas are sounded separately using orthogonal resources via code-, frequency-, and/or time-domain multiplexing.

The main design goals for in-band DMRS-based sounding may be summarized as follows: 1) retain beamforming gain for DMRS, and 2) use the DMRS resources (i.e., CS values, IFDMA comb values, OCC, etc.) as sparingly as possible due to limited capacity. A key notion of how to obtain a viable solution to the above design problem is that the radio channel typically changes fairly slowly in situations where precoding is applied for PUSCH transmission. Actually, the measuring of UE's uplink channel from sounding signal and signaling of precoding parameters from eNB back to UE already takes a few subframes during which the channel is assumed to stay unchanged.

Thus, according to an embodiment, one example of an in-band sounding solution is that the first DMRS symbol in the subframe is precoded while the second DMRS symbol is transmitted without precoding. The DMRS-based PUSCH demodulation may be obtained primarily by using the first DMRS symbol and the in-band sounding may be performed from the second DMRS symbol. With this solution, the first design criterion is achieved but the second one is not since the unprecoded DMRS requires as many orthogonal sequences (via, for example, different cyclic shifts) as there are transmit antennas in the UE. Therefore, certain embodiments provide more sophisticated arrangements that could facilitate joint demodulation and sounding via DMRS as well as increase interference robustness of DMRS and SRS based sounding.

For example, certain embodiments of the invention may be configured to construct an N_{TX}×N_{TX} extended precoding matrix U from the elementary precoding matrices (or vectors) of LTE precoding codebook in such a way that the columns of U are mutually orthogonal. In the case of in-band DMRS-based sounding, one of the elementary matrices of U is identical to PUSCH precoding matrix signaled by eNB to a UE. The rest of the needed elementary matrices may be obtained, for example, from a codebook in a predefined manner. In the case of out-band DMRS based sounding or SRS based sounding, all column vectors of the matrix U may be selected from a codebook in a predefined manner. In one embodiment, an N_{TX}×1 reference signal vector, comprised of multi-antenna elements of a reference signal at a given frequency pin, can be precoded with each column vector of U to form a set of N_{TX} precoded multi-antenna reference signals. The N_{TX} precoded multi-antenna reference signals may be transmitted via N_{TX} antennas by using, for example, mutually orthogonal DMRS and/or SRS resources, where the orthogonal resources are obtained, for example, via code-, frequency-, and/or time-domain multiplexing. According to an embodiment, the channel estimates of the component channels originating from different TX-antennas may be obtained at the receiver side by combining a received set of N_{TX} orthogonally precoded signals. The beamforming gain for PUSCH demodulation can be obtained by exploiting the received signal which was precoded by the PUSCH precoding matrix.

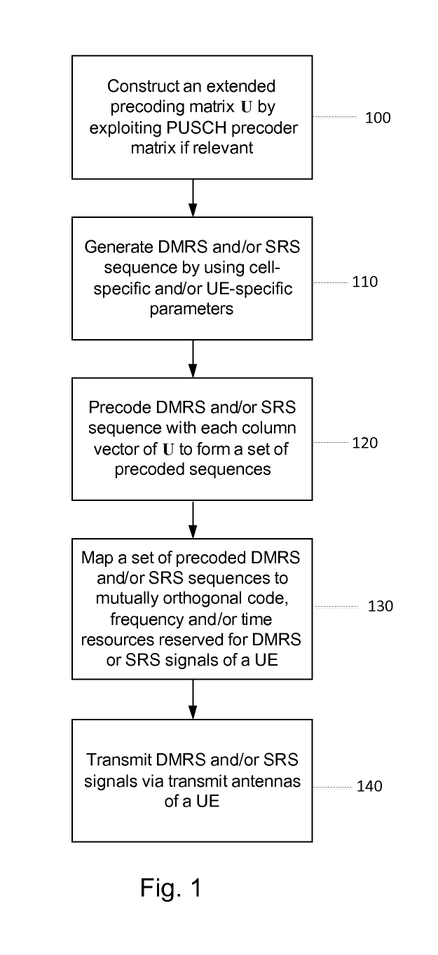

FIG. 1 illustrates an example of a logic flow diagram of a method for generating DMRS or SRS signals, according to one embodiment. In an embodiment, the method of FIG. 1 may be performed at a UE. As illustrated in FIG. 1, the method includes, at 100, constructing an extended precoding matrix U by exploiting the PUSCH precoder matrix if relevant. The method further includes, at 110, generating DMRS and/or SRS sequence by using cell-specific and/or UE-specific parameters. At 120, the method includes precoding DMRS and/or SRS sequence with each column vector of U to form a set of precoded sequences. The method may then include, at 130, mapping a set of precoded DMRS and/or SRS sequences to mutually orthogonal code, frequency and/or time resources reserved for DMRS and/or SRS signals of a UE. The method may further include, at 140, transmitting DMRS and/or SRS signals via transmit antennas of the UE.

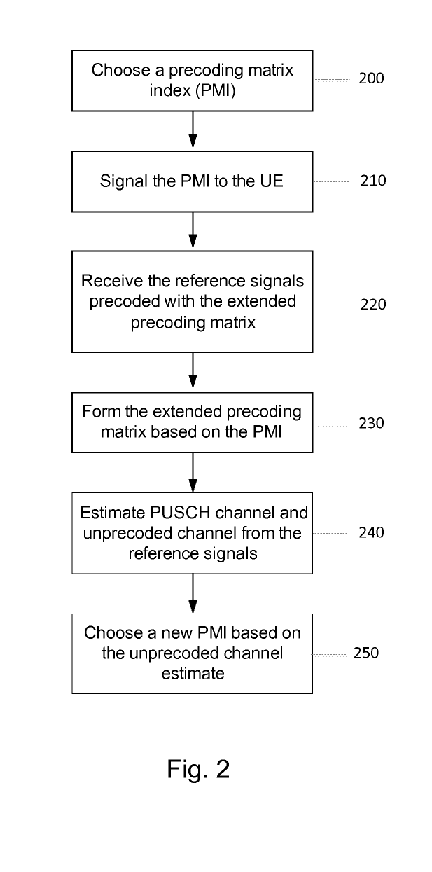

FIG. 2 illustrates a logic flow diagram of a method according to one embodiment. In an embodiment, the method illustrated in FIG. 2 may be performed by an eNodeB. As illustrated in FIG. 2, the method includes, at 200, choosing a precoding matrix index (PMI) and, at 210, signaling the PMI to the UE. At 220, the method includes receiving the reference signals precoded with the extended precoding matrix and, at 230, forming the extended precoding matrix based on the PMI. The method may then include, at 240, estimating the PUSCH channel and unprecoded channel from the reference signals. The method may also include, at 250, choosing a new PMI based on the unprecoded channel estimate.

In some embodiments, the functionality of any of the methods described herein, such as those illustrated in FIGS. 1 and 2, may be implemented by a software stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software.

The LTE UL precoding matrix codebook contains a set of precoding matrices for each combination of a transmission rank N_{L} and a number of transmission antennas N_{TX}. The matrices may be found in 3GPP TS 36.211 V10.4.0 (2011-12), section 5.3.3A, which is hereby incorporated by reference in its entirety. The specific precoding matrix that is used for the PUSCH transmission from the UE is chosen by the eNodeB based on, for example, the received sounding signals from the UE. This PUSCH precoder is denoted by UPUSCH, which is therefore of size N_{TX}×N_{L}. The precoded PUSCH signal is obtained as:

Z_{PUSCH}=U_{PUSCH}y_{PUSCH},

where y_{PUSCH} is the N_{L}×1 vector of transmitted PUSCH symbols.

To facilitate the PUSCH demodulation, the demodulation reference signal (DMRS) is also transmitted from the UE. The transmitted DMRS signal may be expressed as:

Z_{DMRS}=U_{PUSCH}y_{DMRS},

where y_{DMRS} is the transmitted reference signal sequence, which is known to the eNodeB.

The following will consider a case of in-band DMRS-based sounding in detail. According to embodiments of the invention, the UE forms an extended precoding matrix U based on the PUSCH precoding matrix U_{PUSCH}. The extended precoding matrix is of size N_{TX}×N_{TX} and has orthogonal columns. The extended precoding matrix is formed as:

U=[U_{PUSCH}U_{EXT}],

where U_{EXT} is an additional precoding matrix of size N_{TX}×(N_{TX}−N_{L}), which is obtained by a predefined mapping from the employed PUSCH precoder. That is, U_{EXT}=ƒ(U_{PUSCH}). So the requirement for the extended precoding matrix may be expressed as:

Q=[U_{PUSCH}ƒ(U_{PUSCH})]^{H}[U_{PUSCH}ƒ(U_{PUSCH})],

Q(i,j)=0, for i≠j

Q is of size N_{TX}×N_{TX},

where A^{H} denotes the conjugate transpose of matrix A and A(i, j) denotes the (i, j)-th element of matrix A.

It should be noted that the currently specified 2 and 4 TX antenna codebooks contain elements such that the columns of U_{EXT} may be found from the codebook. An exception is the 4 TX antenna case with rank 3 transmission, where the missing column from U may be found by taking the first column of U_{PUSCH} and multiplying the second non-zero element of it by −1. However, this is just an example of how the extended precoding matrix U may be defined. Other possibilities exist since the above given requirement for U does not uniquely define the function f. Furthermore, it is noted that the currently specified PUSCH precoding vectors are defined in such a way that the abovementioned requirement for the matrix U may always be satisfied regardless of the chosen PUSCH precoder.

Once the extended precoding matrix is formed, the UE precodes a reference symbol vector with each column vector of U and maps the obtained set of precoded reference signals to orthogonal DMRS and/or SRS resources. The precoded and mutually orthogonal reference signals are then transmitted to the eNodeB, which then obtains the effective channel estimates.

Letting H denote the N_{RX}×N_{TX} MIMO channel matrix, the effective channel is denoted by H_{eff} and it is given by Heff=H U. The first N_{L} columns of H_{eff} correspond to the PUSCH channel, and these estimates are used in PUSCH decoding. Then, in order to obtain an updated PMI to be used in a following time interval, the eNodeB may form an estimate of the unprecoded MIMO channel matrix by multiplying the estimated effective channel matrix from the right by the inverse of the extended precoding matrix, Heff U−1=H U U−1=H. Since the columns of the extended precoding matrix are mutually orthogonal, the inverse of it may be found simply by first scaling the columns appropriately and then taking the conjugate transpose. The PUSCH precoder may then be updated in light of the newly estimated channel. This updated precoder is then again signaled to the UE and, therefore, subsequently used in the PUSCH transmission. It should be noted that an estimate of the unprecoded MIMO channel matrix H may also be used for other purposes than determining a new value for PMI, such as for facilitating link adaptation and frequency domain packet scheduling procedures.

The mapping of a set of precoded reference signals into physical RS resources can be done in a number of different ways. In practice, some mapping configurations could be defined by standard and the eNodeB could then configure a UE to use some particular configuration depending on the prevailing network conditions and/or channel conditions. Such a configurability built around the proposed “extended” precoding concept could allow efficient handling of many important use cases. Considering, for example, a heterogeneous network where there may exist many small pico cells within a macro cell coverage with relatively small amount of UEs residing in each pico cell and their mobility can be very low. In such a case, a UE may be granted a large bandwidth and, due to low mobility, the re-scheduling of a UE needs to be done rather infrequently. Then, the precoded DMRS signal could be transmitted most of the time using the PUSCH precoder and only occasionally could be transmitted using the other precoders from the extended precoding matrix U in order to perform in-band sounding.

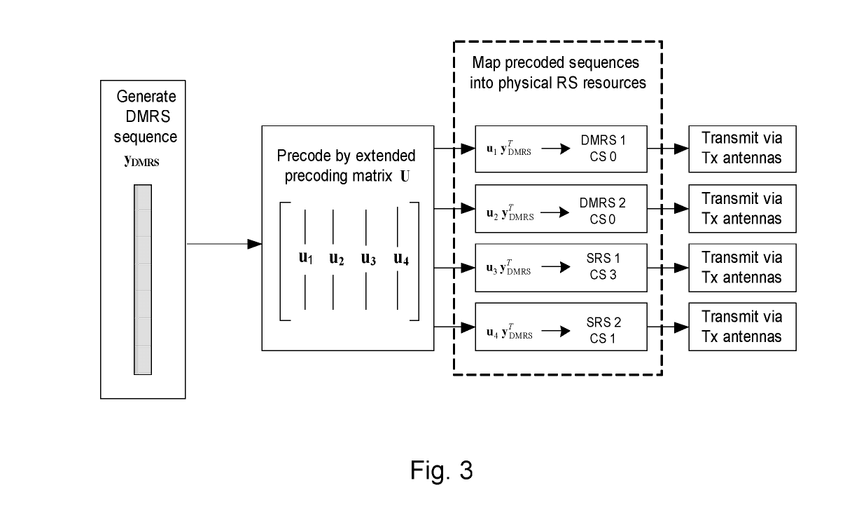

Alternatively, according to one embodiment of the invention, some of the “orthogonally” precoded reference signals could be transmitted using DMRS symbols while the rest of the precoded signals could be transmitted using SRS symbols. An example of such an embodiment of in-band DMRS-based sounding is illustrated in FIG. 3, where a UE is assumed to have 4 Tx antennas to be sounded. In the example of FIG. 3, two of the precoded signals are transmitted using two consecutive DMRS symbols with a cyclic shift 0, while the remaining two precoded signals are mapped to two SRS symbols with cyclic shifts 3 and 1. It should be noted, however, that the mapping of precoded signals into SRS symbols according to the arrangement illustrated in FIG. 3 may require that the second half of the signal sequence to be mapped into SRS is discarded due to the fact that SRS applies interleaved frequency division multiple access (IFDMA) with repetition factor (RPF) of 2.

Thus far, the “extended” precoding concept has been described mainly from an in-band DMRS based sounding perspective. However, a similar arrangement could be applied to the out-band DMRS and SRS based sounding where a kind of spatial spreading by means of unitary matrix U could provide sounding signal with significantly improved interference mitigation compared to prior art methods. This is because a combination of spatial orthogonal coding and allocation of multiple DMRS and/or SRS symbols effectively causes an interference randomization for all sounded Tx antennas due to the DMRS and SRS sequence group hopping and CS hopping applied over different reference symbols. In addition, the interference landscape itself may be quite different as seen from different Tx antennas, as well as in different time instances. Since in this case DMRS and SRS resources are used solely for sounding purposes there is more freedom to define the extended precoded matrix U. In this special case, the matrix U could be, for example, a Hadamard matrix.

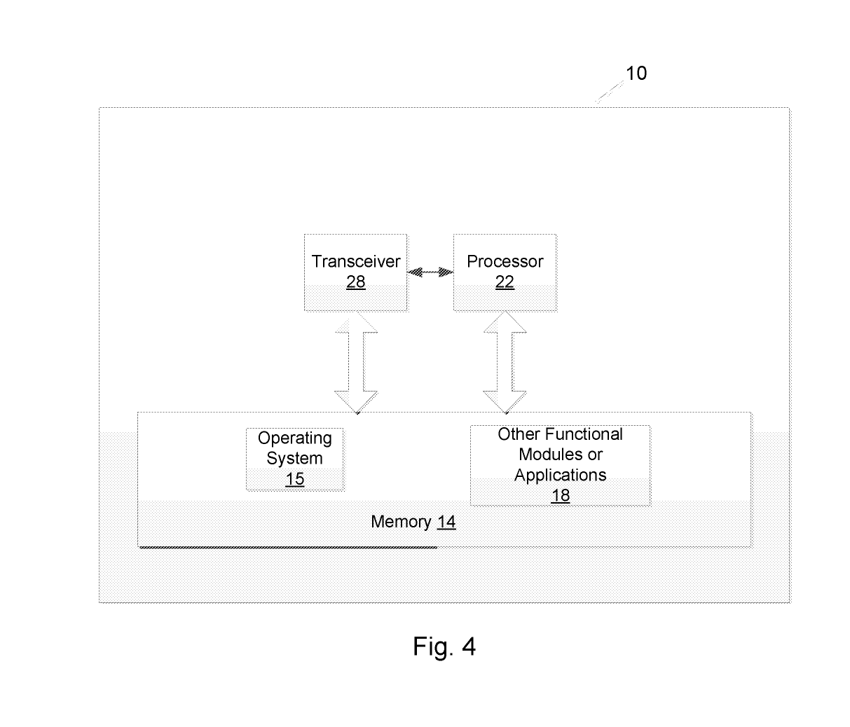

FIG. 4 illustrates an apparatus 10 according to another embodiment. In an embodiment, apparatus 10 may be a UE supporting enhanced multiple transmit antenna sounding. In other embodiments, apparatus 10 may be an eNodeB supporting enhanced multiple transmit antenna sounding.

Apparatus 10 includes a processor 22 for processing information and executing instructions or operations. Processor 22 may be any type of general or specific purpose processor. While a single processor 22 is shown in FIG. 4, multiple processors may be utilized according to other embodiments. In fact, processor 22 may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as examples.

Apparatus 10 further includes a memory 14, coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (“RAM”), read only memory (“ROM”), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

Apparatus 10 may also include one or more antennas (not shown) for transmitting and receiving signals and/or data to and from apparatus 10. Apparatus 10 may further include a transceiver 28 that modulates information on to a carrier waveform for transmission by the antenna(s) and demodulates information received via the antenna(s) for further processing by other elements of apparatus 10. In other embodiments, transceiver 28 may be capable of transmitting and receiving signals or data directly.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 stores software modules that provide functionality when executed by processor 22. The modules may include an operating system 15 that provides operating system functionality for apparatus 10. The memory may also store one or more functional modules 18, such as an application or program, to provide additional functionality for apparatus 10. The components of apparatus 10 may be implemented in hardware, or as any suitable combination of hardware and software.

As mentioned above, according to one embodiment, apparatus 10 may be a UE. In this embodiment, apparatus 10 may be controlled by memory 14 and processor 22 to construct an extended precoding matrix U by exploiting the PUSCH precoder matrix, if relevant. Apparatus 10 may be further controlled by memory 14 and processor 22 to generate a DMRS and/or SRS sequence by using cell-specific and/or UE-specific parameters, and to precode the DMRS and/or SRS sequence with each column vector of U to form a set of precoded sequences. Apparatus 10 may then be further controlled by memory 14 and processor 22 to map the set of precoded DMRS and/or SRS sequences to mutually orthogonal code, frequency and/or time resources reserved for DMRS and/or SRS signals of a UE. In addition, apparatus 10 may be controlled to transmit the DMRS and/or SRS signals via transmit antennas of the UE. In an embodiment, the DMRS and/or SRS signals are transmitted to an eNodeB.

According to another embodiment, apparatus 10 may be an eNodeB. In this embodiment, apparatus 10 may be controlled by memory 14 and processor 22 to choose a precoding matrix index (PMI), and to signal the PMI to the UE. Apparatus 10 may be further controlled by memory 14 and processor 22 to receive the reference signals precoded with the extended precoding matrix, and to form the extended precoding matrix based on the PMI. Apparatus 10 may then be further controlled by memory 14 and processor 22 to estimate the PUSCH channel and unprecoded channel from the reference signals, and to choose a new PMI based on the unprecoded channel estimate.

Embodiments of the invention provide a number of advantages. For example, according to certain embodiments, beamforming gain is retained for DMRS-based demodulation while in-band DMRS-based sounding is feasible. Also, according to certain embodiments, the required number of orthogonal DMRS sequences for joint operation of PUSCH demodulation and in-band sounding is minimized. For out-band DMRS and SRS based sounding enhanced interference mitigation is achieved via improved interference randomization. Additionally, high flexibility is obtained in terms of using DMRS resources for in-band sounding (code-domain, frequency-domain and/or time-domain DMRS resources can be exploited in a flexible way) allowing for the handling of many important use cases in an efficient way. It should be noted that advantages of the present invention are not limited to those discussed above and other advantages may be realized according to embodiments of the invention.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1-22. (canceled)

23. A method, comprising:
constructing, by a user equipment (UE), an extended precoding matrix with mutually orthogonal column vectors;
generating a reference signal sequence;
precoding the reference signal sequence with each column vector of the extended precoding matrix to form a set of precoded sequences; and
mapping the set of precoded sequences to mutually orthogonal code, frequency, and/or time resources reserved for reference signals of the UE.

24. The method according to claim 23, further comprising transmitting the reference signals to an evolved node B (eNodeB).

25. The method according to claim 23, wherein the generating comprises generating the reference signal sequence by using cell-specific and/or UE-specific parameters.

26. The method according to claim 23, wherein the constructing comprises constructing the extended precoding matrix U based on a physical uplink shared channel (PUSCH) precoding matrix U_{PUSCH}, wherein the extended precoding matrix is of size N_{TX}×N_{TX} and has orthogonal columns, and wherein the extended precoding matrix U is formed as:
U=[U_{PUSCH}U_{EXT}],
where U_{EXT} is an additional precoding matrix of size N_{TX}×(N_{TX}−N_{L}).

27. The method according to claim 26, wherein U_{EXT}=ƒ(U_{PUSCH}) and a requirement for the extended precoding matrix may be expressed as:
Q=[U_{PUSCH}ƒ(U_{PUSCH})]^{H}[U_{PUSCH}ƒ(U_{PUSCH})],
Q(i,j)=0, for i≠j
Q is of size N_{TX}×N_{TX},
where A^{H} denotes the conjugate transpose of matrix A and A(i, j) denotes the (i, j)-th element of matrix A.

28. The method according to claim 23, wherein the reference signal sequence comprises a demodulation reference signal (DMRS) sequence or sounding reference signal (SRS) sequence.

29. An apparatus, comprising:
at least one processor; and
at least one memory comprising computer program code,
the at least one memory and the computer program code configured, with the at least one processor, to cause the apparatus at least to
construct an extended precoding matrix with mutually orthogonal column vectors;
generate a reference signal sequence;
precode the reference signal sequence with each column vector of the extended precoding matrix to form a set of precoded sequences; and
mapping the set of precoded sequences to mutually orthogonal code, frequency, and/or time resources reserved for reference signals of the apparatus.

30. The apparatus according to claim 29, wherein the at least one memory and the computer program code are further configured, with the at least one processor, to cause the apparatus at least to transmit the reference signals to an evolved node B (eNodeB).

31. The apparatus according to claim 29, wherein the at least one memory and the computer program code are further configured, with the at least one processor, to cause the apparatus at least to generate the reference signal sequence by using cell-specific and/or user equipment-specific parameters.

32. The apparatus according to claim 29, wherein the at least one memory and the computer program code are further configured, with the at least one processor, to cause the apparatus at least to construct the extended precoding matrix U based on a physical uplink shared channel (PUSCH) precoding matrix U_{PUSCH}, wherein the extended precoding matrix is of size N_{TX}×N_{TX} and has orthogonal columns, and wherein the extended precoding matrix U is formed as:
U=[U_{PUSCH}U_{EXT}],
where U_{EXT} is an additional precoding matrix of size N_{TX}×(N_{TX}−N_{L}).

33. The apparatus according to claim 32, wherein U_{EXT}=ƒ(U_{PUSCH}) and a requirement for the extended precoding matrix may be expressed as:
Q=[U_{PUSCH}ƒ(U_{PUSCH})]^{H}[U_{PUSCH}ƒ(U_{PUSCH})],
Q(i,j)=0, for i≠j
Q is of size N_{TX}×N_{TX},
where A^{H} denotes the conjugate transpose of matrix A and A(i, j) denotes the (i, j)-th element of matrix A.

34. The apparatus according to claim 29, wherein the reference signal sequence comprises a demodulation reference signal (DMRS) sequence or sounding reference signal (SRS) sequence.

35. A computer program, embodied on a computer readable medium, the computer program configured to control a processor to perform a process, comprising:
constructing an extended precoding matrix with mutually orthogonal column vectors;
generating a reference signal sequence;
precoding the reference signal sequence with each column vector of the extended precoding matrix to form a set of precoded sequences; and
mapping the set of precoded sequences to mutually orthogonal code, frequency, and/or time resources reserved for reference signals of the UE.

36. A method, comprising:
choosing, by an evolved node B (eNodeB), a precoding matrix index (PMI);
signaling the precoding matrix index (PMI) to a user equipment (UE);
receiving reference signals precoded with an extended precoding matrix; and
forming the extended precoding matrix based on the precoding matrix index (PMI).

37. The method according to claim 36, further comprising estimating a physical uplink shared channel (PUSCH) and an unprecoded channel from the reference signals.

38. The method according to claim 36, further comprising choosing a new precoding matrix index (PMI) based on the unprecoded channel estimate.

39. An apparatus, comprising:
at least one processor; and
at least one memory comprising computer program code,
the at least one memory and the computer program code configured, with the at least one processor, to cause the apparatus at least to
choose a precoding matrix index (PMI);
signal the precoding matrix index (PMI) to a user equipment (UE);
receive reference signals precoded with an extended precoding matrix; and
form the extended precoding matrix based on the precoding matrix index (PMI).

40. The apparatus according to claim 39, wherein the at least one memory and the computer program code are further configured, with the at least one processor, to cause the apparatus at least to estimate a physical uplink shared channel (PUSCH) and an unprecoded channel from the reference signals.

41. The apparatus according to claim 39, wherein the at least one memory and the computer program code are further configured, with the at least one processor, to cause the apparatus at least to choose a new precoding matrix index (PMI) based on the unprecoded channel estimate.

42. A computer program, embodied on a computer readable medium, the computer program configured to control a processor to perform a process, comprising:
Choosing a precoding matrix index (PMI);
signaling the precoding matrix index (PMI) to a user equipment (UE);
receiving reference signals precoded with an extended precoding matrix; and
forming the extended precoding matrix based on the precoding matrix index (PMI).
